(19) United States
(12) Patent Application Publication
(10) Pub. No.: US 2023/0001887 A1
(43) Pub. Date: Jan. 5, 2023

(54) VEHICLE SECURITY SYSTEM

(71) Applicant: Marcie Carole Layne, Hillsboro, TN (US)

(72) Inventor: Marcie Carole Layne, Hillsboro, TN (US)

(21) Appl. No.: 17/367,557

(22) Filed: Jul. 5, 2021

(51) Int. Cl. B60R 25/30; B60R 25/25; B60R 25/20

(52) U.S. Cl. CPC B60R 25/305; B60R 25/25; B60R 25/2018

(57) ABSTRACT

A vehicle security system connected to an external device running a program thereon, the vehicle security system including a front camera disposed on at least a portion of a front portion of a vehicle to record at least one first visual data of a surrounding area in a front of the vehicle thereon, a plurality of rear cameras disposed on at least a portion of a rear bumper of the vehicle to record at least one second visual data of a surrounding area in a rear of the vehicle thereon, a first mirror camera disposed on at least a portion of a first mirror of the vehicle to record at least one third visual data of a surrounding area on a first side of the vehicle thereon, a second mirror camera disposed on at least a portion of a second mirror of the vehicle to record at least one fourth visual data of a surrounding area on a second side of the vehicle thereon, a roof antenna camera disposed on at least a portion of a roof antenna of the vehicle to record at least one fifth visual data of a surrounding area on a roof of the vehicle thereon, a plurality of interior cameras disposed on at least a portion of a rearview mirror of the vehicle to record at least one sixth visual data of a surrounding area within an interior of the vehicle thereon, and a microphone disposed on at least a portion of the rearview mirror of the vehicle to record at least one audio data of a surrounding area of the vehicle.

### BACKGROUND

### 1. Field

The present general inventive concept relates generally to vehicle security, and particularly, to a vehicle security system.

### 2. Description of the Related Art

Vehicle theft, insurance fraud claims, car crashes, and/or hit and runs are unfortunate situations that some vehicle owners confront when owning a vehicle. In most cases, it is incredibly difficult to identify the thief and/or aggressor by providing hard evidence of such events after they occurred. Moreover, vehicle owners are left unable to receive proper compensation and/or provide police authorities with the required information as most standard security systems are limited to only audio support, using an alarm.

However, the alarm in the vehicle is limited to activating when the thief actually does something to trigger the alarm, such as opening a locked door. However, it doesn't prevent other types of damage, such as scratches and/or denting the vehicle.

Therefore, there is a need for a vehicle security system that records a visual image and/or video around the vehicle in response to activity around the vehicle.

### SUMMARY

The present general inventive concept provides a vehicle security system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a vehicle security system connected to an external device running a program thereon, the vehicle security system including a front camera disposed on at least a portion of a front portion of a vehicle to record at least one first visual data of a surrounding area in a front of the vehicle thereon, a plurality of rear cameras disposed on at least a portion of a rear bumper of the vehicle to record at least one second visual data of a surrounding area in a rear of the vehicle thereon, a first mirror camera disposed on at least a portion of a first mirror of the vehicle to record at least one third visual data of a surrounding area on a first side of the vehicle thereon, a second mirror camera disposed on at least a portion of a second mirror of the vehicle to record at least one fourth visual data of a surrounding area on a second side of the vehicle thereon, a roof antenna camera disposed on at least a portion of a roof antenna of the vehicle to record at least one fifth visual data of a surrounding area on a roof of the vehicle thereon, a plurality of interior cameras disposed on at least a portion of a rearview mirror of the vehicle to record at least one sixth visual data of a surrounding area within an interior of the vehicle thereon, and a microphone disposed on at least a portion of the rearview mirror of the vehicle to record at least one audio data of a surrounding area of the vehicle.

The front camera, each of the plurality of rear cameras, the first mirror camera, the second mirror camera, the roof antenna camera, and each of the plurality of interior cameras each may include a sensor to detect movement within a predetermined proximity thereof.

The microphone may record the at least one audio data in response to detecting a decibel level exceeds a predetermined decibel level reaching the interior of the vehicle.

The microphone may base the predetermined decibel level on a predetermined proximity to the vehicle.

The front camera, the plurality of rear cameras, the first mirror camera, the second mirror camera, the roof antenna camera, and the plurality of interior cameras may transmit data to the external device.

The plurality of rear cameras may collectively generate a panoramic image.

The front camera, the plurality of rear cameras, the first mirror camera, the second mirror camera, the roof antenna camera, the plurality of interior cameras and the microphone may record in response to at least one authorized user being absent from the vehicle and the vehicle is off.

The vehicle security system may further include an identification unit connected to the control unit and at least one third party database to determine a match of at least one unauthorized user recorded on at least one of the front camera, the plurality of rear cameras, the first mirror camera, the second mirror camera, the roof antenna camera, the plurality of interior cameras, and the microphone to identification information extracted from the at least one third party database.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates an elevational side view of a vehicle security system as disposed on a vehicle, according to an exemplary embodiment of the present general inventive concept;

FIG. 2 illustrates a front perspective view of the vehicle security system as disposed on the vehicle, according to an exemplary embodiment of the present general inventive concept; and

FIG. 3 illustrates a rear perspective view of the vehicle security system as disposed on the vehicle, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Vehicle Security System 100

Front Camera 110

Rear Cameras 120

First Rear Camera 121

Second Rear Camera 122

Third Rear Camera 123

Fourth Rear Camera 124

First Mirror Camera 130

Second Mirror Camera 140

Roof Antenna Camera 150

Interior Cameras 160

Microphone 170

Control Unit 180

Identification Unit 190

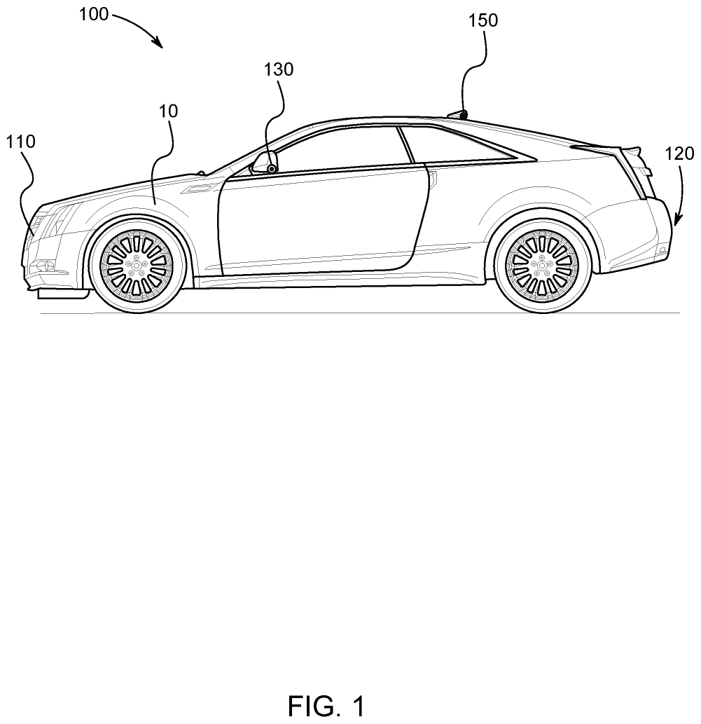

FIG. 1 illustrates an elevational side view of a vehicle security system 100 as disposed on a vehicle 10, according to an exemplary embodiment of the present general inventive concept.

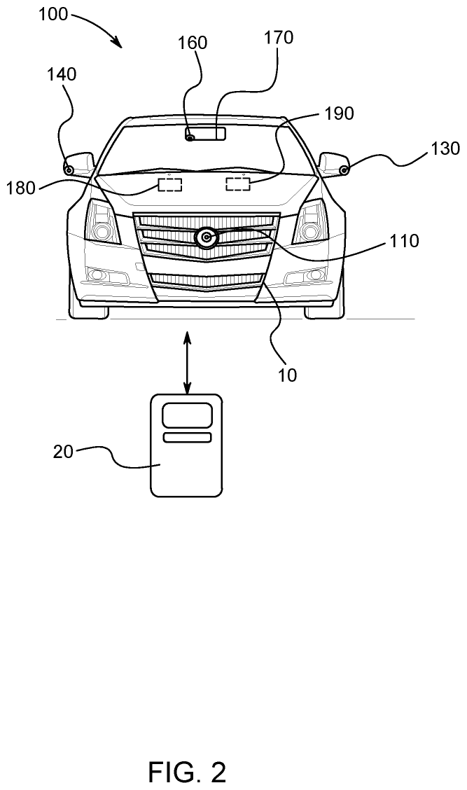

FIG. 2 illustrates a front perspective view of the vehicle security system 100 as disposed on the vehicle 10, according to an exemplary embodiment of the present general inventive concept.

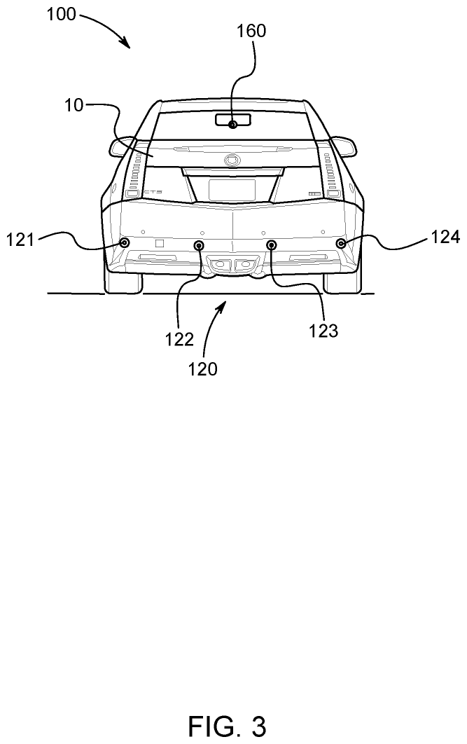

FIG. 3 illustrates a rear perspective view of the vehicle security system 100 as disposed on the vehicle 10, according to an exemplary embodiment of the present general inventive concept.

The vehicle security system 100 may be constructed from at least one of metal, plastic, wood, and rubber, etc., but is not limited thereto.

Referring to FIGS. 1 through 3, the vehicle theft recording system 100 may include a front camera 110, a plurality of rear cameras 120, a first mirror camera 130, a second mirror camera 140, a roof antenna camera 150, a plurality of interior cameras 160, a microphone 170, a control unit 180, and an identification unit 190, but is not limited thereto.

The vehicle security system 100 may be retrofit and/or integrated into a vehicle 10 during manufacture.

The front camera 110, the plurality of rear cameras 120, the first mirror camera 130, the second mirror camera 140, the roof antenna camera 150, and/or the plurality of interior cameras 160 may include any type of camera known to one of ordinary skill in the art, including, but not limited to, an action camera, an animation camera, an autofocus camera, a box camera, a camcorder, a camera phone, a compact camera, a dashboard camera (i.e., a Dashcam), a digital camera, a field camera, a FIREWIRE camera, a helmet camera, a high-speed camera, an instant camera, a keychain camera, a live-preview digital camera, a movie camera, an omnidirectional camera, a pinhole camera, a pocket camera, a pocket video camera, a rangefinder camera, a reflex camera, a remote camera, a stereo camera, a still camera, a still video camera, a subminiature camera, a system camera, a thermal imaging camera, a thermographic camera, a traffic camera, a traffic enforcement camera, a twin-lens reflex camera, a video camera, a view camera, a webcam, a WRIGHT camera, a ZENITH camera, and a zoom-lens reflex camera.

Additionally, the front camera 110, each of the plurality of rear cameras 120, the first mirror camera 130, the second mirror camera 140, the roof antenna camera 150, and/or each of the plurality of interior cameras 160 may further include a motion sensor.

The front camera 110 may be disposed on at least a portion of a front portion of the vehicle 10. The front camera 110 may record at least one first visual data, such as at least one first picture and/or at least one first video thereon. More specifically, the front camera 110 may record the at least one first visual data of a surrounding area in a front of the vehicle 10, including an environment, a person (e.g., an unauthorized user, a thief), and/or an object.

The plurality of rear cameras 120 may include a first rear camera 121, a second rear camera 122, a third rear camera 123, and a fourth rear camera 124, but is not limited thereto.

The first rear camera 121, the second rear camera 122, the third rear camera 123, and/or the fourth rear camera 124 may be disposed on at least a portion of a rear portion of the vehicle 10 opposite with respect to the front portion of the vehicle 10, such as a rear bumper of the vehicle 10. The plurality of rear cameras 120 may record at least one second visual data, such as at least one second picture and/or at least one second video thereon. More specifically, the plurality of rear cameras 120 may record the at least one second visual data of a surrounding area in a rear of the vehicle 10, including an environment, a person, and/or an object.

Also, first rear camera 121, the second rear camera 122, the third rear camera 123, and/or the fourth rear camera 124 may be oriented in different directions with respect to each other to record the at least one second visual data from different angles and/or directions away from the vehicle 10. Therefore, the plurality of rear cameras 120 may record the at least one second visual data in a greater area than a single camera. Also, collectively, the plurality of rear cameras 120 may generate a panoramic image.

Referring to FIG. 2, the first mirror camera 130 may be disposed on at least a portion of a first side of a first mirror of the vehicle 10. The first mirror camera 130 may record at least one third visual data, such as at least one third picture and/or at least one third video thereon. More specifically, the first mirror camera 130 may record the at least one third visual data of a surrounding area on a first side of the vehicle 10, including an environment, a person, and/or an object.

Referring again to FIG. 2, the second mirror camera 140 may be disposed on at least a portion of a first side of a second mirror of the vehicle 10. The second mirror camera 140 may record at least one fourth visual data, such as at least one fourth picture and/or at least one fourth video thereon. More specifically, the second mirror camera 140 may record the at least one fourth visual data of a surrounding area on a second side of the vehicle 10 opposite with respect to the first side of the vehicle 10, including an environment, a person, and/or an object.

Referring to FIG. 3, the roof antenna camera 150 may be disposed on at least a portion of a roof antenna of the vehicle 10. The roof antenna camera 150 may record at least one fifth visual data, such as at least one picture and/or at least one fifth video thereon. More specifically, the roof antenna camera 150 may record the at least one fifth visual data of a surrounding area of the roof antenna and/or a roof of the vehicle 10, including an environment, a person, and/or an object.

Referring to FIGS. 2 and 3, the plurality of interior cameras 160 may be disposed on at least a portion of a rearview mirror of the vehicle 10. The plurality of interior cameras 160 may record at least one sixth visual data, such as at least one picture and/or at least one sixth video thereon. More specifically, the plurality of interior cameras 160 may record the at least one sixth visual data of a surrounding area within an interior of the vehicle 10, including an environment, a person, and/or an object. For example, the plurality of interior cameras 160 may record at least one unauthorized user within an interior of the vehicle 10.

Accordingly, as described above, the front camera 110, the plurality of rear cameras 120, the first mirror camera 130, the second mirror camera 140, the roof antenna camera 150, and/or the plurality of interior cameras 160 may provide different views within and/or outside the vehicle 10.

The microphone 170 may be disposed on at least a portion of the rearview mirror of the vehicle 10. The microphone 170 may record at least one audio data thereon. More specifically, the microphone 170 may record the at least one audio data in response to detecting a decibel level exceeds a predetermined decibel level reaching the interior of the vehicle 10. For example, the microphone 170 may remain off while the decibel level is below the predetermined decibel level. Moreover, the predetermined decibel level may be based on a predetermined proximity to the vehicle 10, such as within fifteen feet of the vehicle 10. However, the predetermined proximity may be adjusted to more than fifteen feet.

The control unit 180 may include an input unit, a processing unit, a communication unit, and a storage unit, but is not limited thereto.

Referring again to FIG. 2, it is important to note that although the control unit 180 is illustrated as a component of the vehicle 10, it may be a separate device (e.g., a computer) located in a remote location, such as a cloud and/or networked computer. Also, the control unit 180 may be integrated within and as a part of the front camera 110, the plurality of rear cameras 120, the first mirror camera 130, the second mirror camera 140, the roof antenna camera 150, and/or the plurality of interior cameras 160.

The input unit of the control unit 180 may include a keyboard, a touchpad, a mouse, a trackball, a stylus, a voice recognition unit, a visual data reader, a camera, a wireless device reader, a fingerprint reader, an iris scanner, a facial recognition unit, and a holographic input unit.

The processing unit of the control unit 180 (or central processing unit, CPU) may include electronic circuitry to carry out instructions of a computer program by performing basic arithmetic, logical, control and input/output (I/O) operations specified by the instructions. The processing unit of the control unit 180 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 180 may also include a microprocessor and a microcontroller.

The communication unit of the control unit 180 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit of the control unit 180 may include a random access memory (RAM), a read-only memory (ROM), a hard disk, a flash drive, a database connected to the Internet, cloud-based storage, Internet-based storage, or any other type of storage unit.

The processing unit of the control unit 180 may access the Internet via the communication unit to allow the user to access a website, and/or may allow a mobile application and/or the software application to be executed using the processing unit. For ease of description, the mobile and/or the software application will be hereinafter referred to as an app. The app may be downloaded from the Internet to be stored on the storage unit of the control unit 180.

The control unit of the control unit 180 may be mechanically and/or electrically connected to at least a portion of the front camera 110, the plurality of rear cameras 120, the first mirror camera 130, the second mirror camera 140, the roof antenna camera 150, and/or the plurality of interior cameras 160. The processing unit of the control unit 180 executing the app may control operations of the front camera 110, the plurality of rear cameras 120, the first mirror camera 130, the second mirror camera 140, the roof antenna camera 150, and/or the plurality of interior cameras 160.

The storage unit of the control unit 180 may store all data from the front camera 110, the plurality of rear cameras 120, the first mirror camera 130, the second mirror camera 140, the roof antenna camera 150, the plurality of interior cameras 160, and/or the microphone 170. Moreover, the processing unit of the control unit 180 may execute the app to control the sensor of the front camera 110, the plurality of rear cameras 120, the first mirror camera 130, the second mirror camera 140, the roof antenna camera 150, and/or the plurality of interior cameras 160 to detect movement within the predetermined proximity of the front camera 110, the plurality of rear cameras 120, the first mirror camera 130, the second mirror camera 140, the roof antenna camera 150, and/or the plurality of interior cameras 160. In other words, the front camera 110, the plurality of rear cameras 120, the first mirror camera 130, the second mirror camera 140, the roof antenna camera 150, and/or the plurality of interior cameras 160 may record in response to detecting movement within the surrounding area, such as from the at least one unauthorized user, such that the processing unit of the control unit 180 may not detect a presence of the at least one authorized user using an external device 20, which may also run the app thereon. The microphone 170 may record at least one audio data in response to the front camera 110, the plurality of rear cameras 120, the first mirror camera 130, the second mirror camera 140, the roof antenna camera 150, and/or the plurality of interior cameras 160 detecting moving within the predetermined proximity.

Furthermore, the motion sensors within the front camera 110, the plurality of rear cameras 120, the first mirror camera 130, the second mirror camera 140, the roof antenna camera 150, and/or the plurality of interior cameras 160 may record while the vehicle 10 is parked and/or turned off, and/or the at least one authorized user is absent from the vehicle 10 (e.g., more than fifteen feet away from the vehicle 10). Also, the front camera 110, the plurality of rear cameras 120, the first mirror camera 130, the second mirror camera 140, the roof antenna camera 150, and/or the plurality of interior cameras 160 may remain off while the at least one authorized user is present even while the at least one unauthorized user is within the predetermined proximity.

The processing unit of the control unit 180 executing the app may be configured to transmit an alert signal via the communication unit to the external device 20 of the at least one authorized user in response to detecting movement within the surrounding area.

The front camera 110, the plurality of rear cameras 120, the first mirror camera 130, the second mirror camera 140, the roof antenna camera 150, and/or the plurality of interior cameras 160 may be configured using the processing unit of the control unit 180 executing the app to record on each of the cameras and/or transmit the alert signal via the communication unit to the external device 20 of the at least one authorized user while the vehicle 10 is parked and/or inactive (e.g., off).

Also, the processing unit of the control unit 180 executing the app may be configured to transmit the alert signal via the communication unit to the external device 20 of the at least one authorized user in response to the at least one unauthorized user being within the predetermined proximity of the vehicle 10, such as fifteen feet.

Also, any recording stored within the control unit 180 may be transferred over a network and/or physically through a connection port within the vehicle 10 to an external storage device, such as a flash drive for portability.

The identification unit 190 may be disposed within at least a portion of the interior of the vehicle and communicably connected to at least one third party database and/the control unit 180, such as a law enforcement database and/or a department of motor vehicles (DMV). Moreover, the identification unit 190 may extract identification information from the at least one third party database. The identification unit 190 may use facial recognition, voice recognition, and/or body recognition to determine a match of the at least one unauthorized user recorded by the front camera 110, the plurality of rear cameras 120, the first mirror camera 130, the second mirror camera 140, the roof antenna camera 150, the plurality of interior cameras 160, and/or the microphone 170 to the identification information. As such, the identification unit 190 may provide a name and/or physical characteristics to the at least one authorized user on the external device 20 using the app.

Therefore, the vehicle security system 100 may provide a visual record and/or an audio record of the at least one unauthorized user around the vehicle 10 while the at least one authorized user is not present.

The present general inventive concept may include a vehicle security system 100 connected to an external device 20 running a program thereon, the vehicle security system 100 including a front camera 110 disposed on at least a portion of a front portion of a vehicle 10 to record at least one first visual data of a surrounding area in a front of the vehicle 10 thereon, a plurality of rear cameras 120 disposed on at least a portion of a rear bumper of the vehicle 10 to record at least one second visual data of a surrounding area in a rear of the vehicle 10 thereon, a first mirror camera 130 disposed on at least a portion of a first mirror of the vehicle 10 to record at least one third visual data of a surrounding area on a first side of the vehicle 10 thereon, a second mirror camera 140 disposed on at least a portion of a second mirror of the vehicle 10 to record at least one fourth visual data of a surrounding area on a second side of the vehicle 10 thereon, a roof antenna camera 150 disposed on at least a portion of a roof antenna of the vehicle 10 to record at least one fifth visual data of a surrounding area on a roof of the vehicle 10 thereon, a plurality of interior cameras 160 disposed on at least a portion of a rearview mirror of the vehicle 10 to record at least one sixth visual data of a surrounding area within an interior of the vehicle 10 thereon, and a microphone 170 disposed on at least a portion of the rearview mirror of the vehicle 10 to record at least one audio data of a surrounding area of the vehicle 10.

The front camera 110, each of the plurality of rear cameras 120, the first mirror camera 130, the second mirror camera 140, the roof antenna camera 150, and each of the plurality of interior cameras 160 each may include a sensor to detect movement within a predetermined proximity thereof.

The microphone 170 may record the at least one audio data in response to detecting a decibel level exceeds a predetermined decibel level reaching the interior of the vehicle 10.

The microphone 170 may base the predetermined decibel level on a predetermined proximity to the vehicle 10.

The front camera 110, the plurality of rear cameras 120, the first mirror camera 130, the second mirror camera 140, the roof antenna camera 150, and the plurality of interior cameras 160 may transmit data to the external device 20.

The plurality of rear cameras 120 may collectively generate a panoramic image.

The front camera 110, the plurality of rear cameras 120, the first mirror camera 130, the second mirror camera 140, the roof antenna camera 150, the plurality of interior cameras 160 and the microphone 170 may record in response to at least one authorized user being absent from the vehicle 10 and the vehicle 10 is off.

The vehicle security system 100 may further include an identification unit 190 connected to at least one third party database to determine a match of at least one unauthorized user recorded on at least one of the front camera 110, the plurality of rear cameras 120, the first mirror camera 130, the second mirror camera 140, the roof antenna camera 150, the plurality of interior cameras 160, and the microphone 170 to identification information extracted from the at least one third party database.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A vehicle security system connected to an external device running a program thereon, the vehicle security system comprising:
a front camera disposed on at least a portion of a front portion of a vehicle to record at least one first visual data of a surrounding area in a front of the vehicle thereon;
a plurality of rear cameras disposed on at least a portion of a rear bumper of the vehicle to record at least one second visual data of a surrounding area in a rear of the vehicle thereon;
a first mirror camera disposed on at least a portion of a first mirror of the vehicle to record at least one third visual data of a surrounding area on a first side of the vehicle thereon;
a second mirror camera disposed on at least a portion of a second mirror of the vehicle to record at least one fourth visual data of a surrounding area on a second side of the vehicle thereon;
a roof antenna camera disposed on at least a portion of a roof antenna of the vehicle to record at least one fifth visual data of a surrounding area on a roof of the vehicle thereon;
a plurality of interior cameras disposed on at least a portion of a rearview mirror of the vehicle to record at least one sixth visual data of a surrounding area within an interior of the vehicle thereon, such that the front camera, the plurality of rear cameras, the first mirror camera, the second mirror camera, the roof antenna camera, and the plurality of interior cameras remain off while at least one authorized user remains in a predetermined proximity of the vehicle even while at least one unauthorized user is within the predetermined proximity; and
a microphone disposed on at least a portion of the rearview mirror of the vehicle to record at least one audio data of a surrounding area of the vehicle.

2. The vehicle security system of claim 1, wherein the front camera, each of the plurality of rear cameras, the first mirror camera, the second mirror camera, the roof antenna camera, and each of the plurality of interior cameras each comprise:
a sensor to detect movement within a predetermined proximity thereof.

3. The vehicle security system of claim 1, wherein the microphone records the at least one audio data in response to detecting a decibel level exceeds a predetermined decibel level reaching the interior of the vehicle.

4. The vehicle security system of claim 3, wherein the microphone bases the predetermined decibel level on the predetermined proximity to the vehicle.

5. The vehicle security system of claim 1, wherein the front camera, the plurality of rear cameras, the first mirror camera, the second mirror camera, the roof antenna camera, and the plurality of interior cameras transmit data to the external device.

6. The vehicle security system of claim 1, wherein the plurality of rear cameras collectively generate a panoramic image.

7. The vehicle security system of claim 1, wherein the front camera, the plurality of rear cameras, the first mirror camera, the second mirror camera, the roof antenna camera, the plurality of interior cameras and the microphone record in response to the at least one authorized user being absent from the vehicle and the vehicle is off.

8. The vehicle security system of claim 1, further comprising:
an identification unit connected to at least one third party database to determine a match of the at least one unauthorized user recorded on at least one of the front camera, the plurality of rear cameras, the first mirror camera, the second mirror camera, the roof antenna camera, the plurality of interior cameras, and the microphone to identification information extracted from the at least one third party database.

9. A vehicle security system connected to an external device running a program thereon, the vehicle security system comprising:
a front camera disposed on at least a portion of a front portion of a vehicle to record at least one first visual data of a surrounding area in a front of the vehicle thereon;
a plurality of rear cameras disposed on at least a portion of a rear bumper of the vehicle to record at least one second visual data of a surrounding area in a rear of the vehicle thereon;
a first mirror camera disposed on at least a portion of a first mirror of the vehicle to record at least one third visual data of a surrounding area on a first side of the vehicle thereon;
a second mirror camera disposed on at least a portion of a second mirror of the vehicle to record at least one fourth visual data of a surrounding area on a second side of the vehicle thereon;
a roof antenna camera disposed on at least a portion of a roof antenna of the vehicle to record at least one fifth visual data of a surrounding area on a roof of the vehicle thereon;
a plurality of interior cameras disposed on at least a portion of a rearview mirror of the vehicle to record at least one sixth visual data of a surrounding area within an interior of the vehicle thereon, such that the front camera, the plurality of rear cameras, the first mirror camera, the second mirror camera, the roof antenna camera, and the plurality of interior cameras remain off while at least one authorized user remains within fifteen feet of the vehicle, and record while the at least one authorized user is greater than fifteen feet from the vehicle and at least one unauthorized user is within fifteen feet of the vehicle; and
a microphone disposed on at least a portion of the rearview mirror of the vehicle to record at least one audio data of a surrounding area of the vehicle.
